(19) United States
(12) Patent Application Publication
(10) Pub. No.: US 2025/0037208 A1
(43) Pub. Date: Jan. 30, 2025

(54) SYSTEMS AND METHODS FOR ADAPTIVE DETERMINATION OF HEALTHCARE CLAIM INTEGRITY

(71) Applicant: Codoxo, Inc., Duluth, GA (US)

(72) Inventors: Musheer Ahmed, Lawrenceville, GA (US); Prasoon Saurabh, Alpharetta, GA (US)

(73) Assignee: Codoxo, Inc., Duluth, GA (US)

(21) Appl. No.: 18/786,866

(22) Filed: Jul. 29, 2024

Related U.S. Application Data
(60) Provisional application No. 63/516,341, filed on Jul. 28, 2023.

(51) Int. Cl. G06Q 40/08; G06V 30/412

(52) U.S. Cl. CPC G06Q 40/08; G06V 30/412

(57) ABSTRACT

Systems and methods are provided for adaptive determination of healthcare claim integrity. The method can involve operating at least one processor to receive a healthcare claim request from a computing device; and apply initial healthcare claim request data to a claim integrity model to predict an initial integrity of the claim request. In response to the initial integrity prediction being indicative that the claim request lacks integrity, the at least one processor can automatically generate supplementary data requests for supplementary documents associated with the claim request; transmit the supplementary data requests to corresponding computing devices associated with the supplementary documents; receive at least one supplementary document; extract supplementary healthcare claim data from the supplementary documents received; apply the initial healthcare claim data and supplementary healthcare claim data to the claim integrity model to generate a subsequent integrity indicator; and transmit the subsequent integrity indicator to the computing device for display.

### CROSS-REFERENCE TO RELATED APPLICATIONS

This application claims priority from U.S. Provisional Patent Application No. 63/516,341 filed on Jul. 28, 2023. The entire contents of U.S. Provisional Patent Application No. 63/516,341 is herein incorporated by reference for all purposes.

### FIELD

The described embodiments relate to healthcare claims, and in particular, systems and methods for adaptive determination of healthcare claim integrity.

### BACKGROUND

Healthcare spending is a significant expense in many nations. For example, according to The Centers for Medicare and Medicaid Services (CMS) in the United States (the U.S.), healthcare spending in the U.S. in 2021 totaled 18.3% of gross domestic product (GDP). Healthcare payments involve many distinct organizations including, for example, healthcare providers, hospital systems, pharmacy systems, independent providers, insurance companies, and patients.

The large amount of data related to healthcare payments and the many distinct organizations involved in the healthcare payments can pose challenges in ensuring the integrity of healthcare claims. Healthcare claim integrity can relate to various processes, such as but not limited to, verifying correct payer and payee parties; ensuring adherence to various laws, rules, regulations, policies and contracts; and detecting and preventing fraud, waste, abuse, and errors.

### SUMMARY

The following summary is provided to introduce the reader to the more detailed discussion to follow. The summary is not intended to limit or define any claimed or as yet unclaimed invention. One or more inventions may reside in any combination or sub-combination of the elements or process steps disclosed in any part of this document including its claims and figures.

The various embodiments described herein generally relate to methods (and associated systems configured to implement the methods) adaptive determination of healthcare claim integrity. Example methods involve operating at least one processor to: receive a healthcare claim request from a computing device, the healthcare claim request including initial healthcare claim request data; and apply the initial healthcare claim request data to at least one claim integrity model to predict an initial integrity of the healthcare claim request. In response to the initial integrity prediction being indicative that the healthcare claim request lacks integrity, the method involves operating the at least one processor to: automatically generate one or more supplementary data requests for one or more supplementary documents associated with the healthcare claim request; transmit the one or more supplementary data requests to corresponding computing devices associated with the one or more supplementary documents; receive at least one supplementary document of the one or more supplementary documents; extract supplementary healthcare claim data from the at least one supplementary documents received; apply the initial healthcare claim data and supplementary healthcare claim data to the at least one claim integrity model to generate a subsequent integrity indicator; and transmit the subsequent integrity indicator to the computing device for display. Otherwise, the method involves operating the at least one processor to transmit the initial integrity indicator to the computing device for display.

In some embodiments, the computer-implemented method can involve operating the at least one processor to: receive a second supplementary document after transmitting a first subsequent integrity indicator to the computing device for display, re-apply the initial healthcare claim data and supplementary healthcare claim data from the first supplementary document and the second supplementary document to the at least one claim integrity model to generate a second subsequent integrity indicator; compare the second subsequent integrity indicator with the first subsequent integrity indicator; and in response to determining that the second subsequent integrity indicator is different from the first subsequent integrity indicator, transmit the second subsequent integrity indicator to the computing device for display. The first subsequent integrity indicator can be based on the initial healthcare claim data and supplementary healthcare claim data from a first supplementary document.

In some embodiments, the computer-implemented method can involve operating the at least one processor to: apply the initial healthcare claim request data to a first claim integrity model to predict the initial integrity of the healthcare claim request; and apply the initial healthcare claim data and supplementary healthcare claim data to a second claim integrity model to generate the subsequent integrity indicator.

In some embodiments, the healthcare claim request can include a pre-authorization request.

In some embodiments, the initial integrity of the healthcare claim request can be binary.

In some embodiments, the computer-implemented method can involve operating the at least one processor to apply a generative artificial intelligence (AI) model to automatically generate one or more supplementary data requests for one or more supplementary documents associated with the healthcare claim request and extract supplementary healthcare claim data from the at least one supplementary documents received.

In some embodiments, the computer-implemented method can involve operating the at least one processor to apply natural language processing to extract the supplementary healthcare claim data from the at least one supplementary documents received, the supplementary healthcare claim data comprising at least one health-specific token representative of text data within the at least one supplementary document received.

In some embodiments, the computer-implemented method can further involve operating the at least one processor to apply optical character recognition to extract the supplementary healthcare claim data from the at least one supplementary documents received.

In some embodiments, the computer-implemented method can involve operating the at least one processor to: receive a health record of a patient associated with the healthcare claim request; and extract one or more health elements from the health record. Each of the one or more health elements can correspond to demographic information, healthcare provider information, facility information, a symptom, a condition, a diagnosis, a procedure, a treatment, a medication, or an incident experienced by the patient.

In some embodiments, the computer-implemented method can involve operating the at least one processor to: receive an invoice corresponding to the healthcare claim request and extract one or more invoiced items from the invoice. Each of the one or more invoiced items can have a claim code corresponding to a procedure, a treatment, or a service provided to the patient. The method can further involve operating the at least one processor to, for each invoiced item of the one or more invoiced items, compare the invoiced item to the one or more health elements of the health record; and generate an item integrity indicator for the invoiced item at least based on the comparison of the invoiced item to the one or more health elements.

In some embodiments, the computer-implemented method can involve operating the at least one processor to, in response to determining that none of the one or more health elements are associated with the invoiced item, generate the item integrity indicator as being indicative of a lack of integrity.

In some embodiments, the computer-implemented method can involve operating the at least one processor to: receive a policy document associated with the healthcare claim request; and extract one or more policy elements from the policy document. Each policy element can include one or more rules related to one or more claim codes. Each rule of the one or more rules can be either a permissive rule or a restrictive rule. The method can further involve, for each invoiced item of the one or more invoiced items, compare the claim code of the invoiced item to at least one rule that is related to the claim code of the invoiced item; and generate the item integrity indicator for the invoiced item at least based on the comparison of the invoiced item to the at least one rules.

In some embodiments, the computer-implemented method can involve operating the at least one processor to: in response to determining that the claim code complies with one or more restrictive rules related to the claim code, generate the item integrity indicator as being indicative of a lack of integrity; and in response to determining that the claim code does not comply with any restrictive rules related to the claim code and determining that the claim code complies with one or more permissive rules related to the claim code, generate the item integrity indicator as being indicative of a sufficient integrity.

In some embodiments, the item integrity indicator for each invoiced item of the one or more invoiced items can be binary.

In some embodiments, the computer-implemented method can involve operating the at least one processor to generate the subsequent integrity indicator based on the item integrity of each of the one or more invoiced items of the invoice.

In some embodiments, the computer-implemented method can involve operating the at least one processor to train the at least one claim integrity model using the initial integrity prediction, the subsequent integrity indicator, the initial healthcare claim data, and the supplementary healthcare claim data.

In some embodiments, the computer-implemented method can involve operating the at least one processor to: generate one or more pointers, each pointer being associated with a portion of the at least one supplementary document; generate a summary of the at least one supplementary document; and transmit the summary of the at least one supplementary document with the subsequent integrity indicator to the computing device for display. The summary can include at least a portion of the supplementary healthcare claim data extracted from the at least one supplementary document and at least one pointer related to the supplementary healthcare claim data. The at least one pointer related to the supplementary healthcare claim data can be one of the one or more pointers of the at least one supplementary document.

In another broad aspect, a system for adaptive determination of healthcare claim integrity is provided. The system includes at least one processor configured to: receive a healthcare claim request from a computing device, the healthcare claim request includes initial healthcare claim request data; and apply the initial healthcare claim request data to at least one claim integrity model to predict an initial integrity of the healthcare claim request. In response to the initial integrity prediction being indicative that the healthcare claim request lacks integrity, the at least one processor is configured to: automatically generate one or more supplementary data requests for one or more supplementary documents associated with the healthcare claim request; transmit the one or more supplementary data requests to corresponding computing devices associated with the one or more supplementary documents; receive at least one supplementary document of the one or more supplementary documents; extract supplementary healthcare claim data from the at least one supplementary documents received; apply the initial healthcare claim data and supplementary healthcare claim data to the at least one claim integrity model to generate a subsequent integrity indicator; and transmit the subsequent integrity indicator to the computing device for display. Otherwise, the at least one processor is configured to transmit the initial integrity indicator to the computing device for display.

In some embodiments, the at least one processor can be configured to: receive a second supplementary document after transmitting a first subsequent integrity indicator to the computing device for display, re-apply the initial healthcare claim data and supplementary healthcare claim data from the first supplementary document and the second supplementary document to the at least one claim integrity model to generate a second subsequent integrity indicator; compare the second subsequent integrity indicator with the first subsequent integrity indicator; and in response to determining that the second subsequent integrity indicator is different from the first subsequent integrity indicator, transmit the second subsequent integrity indicator to the computing device for display. The first subsequent integrity indicator can be based on the initial healthcare claim data and supplementary healthcare claim data from a first supplementary document.

In some embodiments, the at least one processor can be configured to: apply the initial healthcare claim request data to a first claim integrity model to predict the initial integrity of the healthcare claim request; and apply the initial healthcare claim data and supplementary healthcare claim data to a second claim integrity model to generate the subsequent integrity indicator.

In some embodiments, the healthcare claim request can include a pre-authorization request.

In some embodiments, the initial integrity of the healthcare claim request can be binary.

In some embodiments, the at least one processor can be configured to apply a generative artificial intelligence (AI) model to automatically generate one or more supplementary data requests for one or more supplementary documents associated with the healthcare claim request and extract supplementary healthcare claim data from the at least one supplementary documents received.

In some embodiments, the at least one processor can be configured to apply natural language processing to extract the supplementary healthcare claim data from the at least one supplementary documents received. The supplementary healthcare claim data can include at least one health-specific token representative of text data within the at least one supplementary document received.

In some embodiments, the at least one processor can be further configured to apply optical character recognition to extract the supplementary healthcare claim data from the at least one supplementary documents received.

In some embodiments, the at least one processor can be configured to: receive a health record of a patient associated with the healthcare claim request; and extract one or more health elements from the health record. Each of the one or more health elements can correspond to demographic information, healthcare provider information, facility information, a symptom, a condition, a diagnosis, a procedure, a treatment, a medication, or an incident experienced by the patient.

In some embodiments, the at least one processor can be configured to: receive an invoice corresponding to the healthcare claim request; and extract one or more invoiced items from the invoice. Each of the one or more invoiced items can have a claim code corresponding to a procedure, a treatment, or a service provided to the patient. The at least one processor can be further configured to, for each invoiced item of the one or more invoiced items, compare the invoiced item to the one or more health elements of the health record; and generate an item integrity indicator for the invoiced item at least based on the comparison of the invoiced item to the one or more health elements.

In some embodiments, the at least one processor can be configured to, in response to determining that none of the one or more health elements are associated with the invoiced item, generate the item integrity indicator as being indicative of a lack of integrity.

In some embodiments, the at least one processor can be configured to: receive a policy document associated with the healthcare claim request; and extract one or more policy elements from the policy document. Each policy element can include one or more rules related to one or more claim codes. Each rule of the one or more rules can be either a permissive rule or a restrictive rule. The at least one processor can be further configured to, for each invoiced item of the one or more invoiced items, compare the claim code of the invoiced item to at least one rule that is related to the claim code of the invoiced item; and generate the item integrity indicator for the invoiced item at least based on the comparison of the invoiced item to the at least one rules.

In some embodiments, the at least one processor can be configured to:
in response to determining that the claim code complies with one or more restrictive rules related to the claim code, generate the item integrity indicator as being indicative of a lack of integrity; and in response to determining that the claim code does not comply with any restrictive rules related to the claim code and determining that the claim code complies with one or more permissive rules related to the claim code, generate the item integrity indicator as being indicative of a sufficient integrity.

In some embodiments, the item integrity for each invoiced item of the one or more invoiced items can be binary.

In some embodiments, the at least one processor can be configured to generate the subsequent integrity indicator based on the item integrity of each of the one or more invoiced items of the invoice.

In some embodiments, the at least one processor can be configured to train the at least one claim integrity model using the initial integrity prediction, the subsequent integrity indicator, the initial healthcare claim data, and the supplementary healthcare claim data.

In some embodiments, the at least one processor can be configured to: generate one or more pointers, each pointer being associated with a portion of the at least one supplementary document; generate a summary of the at least one supplementary document; and transmit the summary of the at least one supplementary document with the subsequent integrity indicator to the computing device for display. The summary can include at least a portion the supplementary healthcare claim data extracted from the at least one supplementary document and at least one pointer related to the supplementary healthcare claim data, the at least one pointer related to the supplementary healthcare claim data being one of the one or more pointers of the at least one supplementary document.

### BRIEF DESCRIPTION OF THE DRAWINGS

Several embodiments will now be described in detail with reference to the drawings, in which:

FIG. 1 is a block diagram of components interacting with an example healthcare claim assessment system, in accordance with an example embodiment;

FIG. 2 is a flowchart of an example embodiment of various methods for determining healthcare claim integrity;

FIG. 3 is a diagram of an example data flow for determining healthcare claim integrity using an example claim integrity model; and

FIG. 4 is a diagram of an example data flow for training the example claim integrity model of FIG. 3.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The large amount of data related to healthcare payments can include data equivalent to hundreds of pages of descriptive text. For example, a patients' medical record alone can be hundreds of pages long. Reviewing such large amounts of data to assess payment of each healthcare claim can be time intensive. Furthermore, such review is usually conducted by someone knowledgeable of medical conditions and related treatments and procedures, such as a clinician or nurse. As well, the relevant data may not be on hand for the reviewer but instead reside with various distinct organizations involved in providing the care. This can further pose challenges in reviewing the healthcare claims.

In response to long processing times and/or high processing costs associated with processing healthcare claims, some healthcare payors adopt a threshold amount for reviewing healthcare claims. For example, healthcare claims less than the threshold amount may be paid without review and healthcare claims greater than the threshold amount may require review to determine payment. In some cases, the threshold amount can be within a range of $50,000 to $100,000, such as, for example $90,000. However, fraud, waste, abuse, or errors, such as but not limited to, billing for healthcare services that were not rendered, upcoding, and double billing, can still occur in healthcare at these lower amounts.

The disclosed systems and methods can assess the healthcare claims to detect or prevent fraud, waste, abuse or errors in healthcare claims. Healthcare claim integrity can relate to various processes, such as but not limited to, verifying correct payer and payee parties; ensuring adherence to various laws, rules, regulations, policies and contracts; and detecting and preventing fraud, waste, abuse, and errors.

The various embodiments described herein generally relate to methods (and associated systems configured to implement the methods) for adaptive determination of healthcare claim integrity. The systems and methods can use artificial intelligence or machine learning models to generate healthcare claim integrity indicators, generate custom requests for supplementary data adapted to the initial healthcare claim data, and further adapt the healthcare claim integrity based on the supplementary data.

The disclosed systems and methods can generate an integrity indicator for a healthcare claim. The integrity indicator of a healthcare claim can be used to assess healthcare claims. For example, the disclosed systems and methods can receive healthcare claim data and generate a healthcare claim integrity indicator for one or more healthcare claims included in the healthcare claim data. The disclosed systems and methods can verify that the healthcare claims are accurate (e.g., correct payer and payee parties) and compliant with applicable policies. The disclosed systems and methods can also verify that various healthcare services and procedures included in the healthcare claims are assigned to appropriate/accurate medical codes that are used for processing corresponding healthcare payments.

The disclosed systems and methods can improve processing speed and/or reduce processing cost of determining the integrity of an associated healthcare claim. For example, a healthcare claim request may include one or more medical/claim codes. For each medical/claim code, the disclosed systems and methods can process the associated healthcare claim data to identify whether there is any support/justification for that medical/claim code. The disclosed systems and methods can generate an integrity indicator based on whether the support/justification is identified. Further, if support/justification is identified, the disclosed systems and methods can provide a user output identifying the portion of the healthcare claim data where the support/justification was identified.

The disclosed systems and methods can generate integrity indicators regarding the assessed healthcare claims. A user may utilize the integrity indicators to make decisions regarding the healthcare claims. Additionally, the disclosed systems and methods can generate summary explanations of reasoning used to provide the integrity indicator. The summary explanations may be used by healthcare payment auditors to review the healthcare claims for any healthcare claim integrity issues, for example, errors or irregularities. The healthcare payment auditors can include, for example, payers (e.g., insurance companies), healthcare providers (e.g., clinicians), or third-party vendors providing healthcare auditing services.

The faster processing speeds and/or reduced processing costs provided by the disclosed systems and methods can enable healthcare payment auditors to eliminate usage of threshold amounts, or lower the threshold amount, and generate the integrity indicator of more received healthcare claim requests.

The disclosed systems and methods may be implemented in different settings. For example, the disclosed systems and methods may be utilized by clinicians, insurance companies and/or healthcare payment auditors to determine healthcare claim integrity. The healthcare claims may be related to any healthcare services and/or products including for example, diagnostic services, surgeries, drugs, etc.

The healthcare services and/or products may be provided in in-patient or out-patient settings. The healthcare payment data may be processed in pre-pay or post-pay settings. For example, in pre-pay settings, a user may utilize the integrity indicators provided by the disclosed systems and methods to approve or reject a healthcare claim. As another example, in post-pay settings, a user may utilize the integrity indicators provided by the disclosed systems and methods to initiate payment recovery process for a healthcare claim.

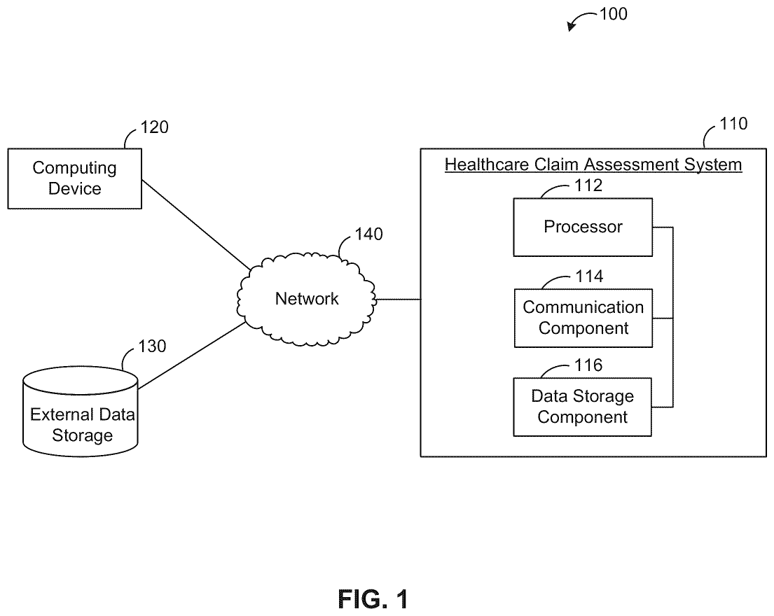

Reference will now be made to FIG. 1, which is a block diagram 100 of components interacting with an example healthcare claim assessment system 110. As shown in FIG. 1, the healthcare claim assessment system 110 is in communication with a computing device 120 and an external data storage 130 via a network 140.

The healthcare claim assessment system 110 includes a processor 112, a communication component 114, and a data storage component 116. The healthcare claim assessment system 110 can be provided on one or more computer servers that may be distributed over a wide geographic area and connected via the network 140.

The healthcare claim assessment system 110 can perform various functions related to assessment of healthcare claims and determining healthcare claim integrity. For example, the healthcare claim assessment system 110 can receive data, such as healthcare claim data, from computing device 120. The healthcare claim assessment system 110 can also access data, such as CMS policies, payer policies, reject codes, stored in external data storage 130. The healthcare claim assessment system 110 can utilize one or more artificial intelligence (AI) models to generate a healthcare claim integrity indicator for one or more healthcare claims included in the received healthcare claim data.

In some embodiments, each of the processor 112, the communication component 114, and the data storage component 116 can be combined into a fewer number of components or may be separated into further components. The processor 112, the communication component 114, and the data storage component 116 can be implemented in software or hardware, or a combination of software and hardware.

The processor 112 can operate to control the operation of the healthcare claim assessment system 110. The processor 112 can initiate and manage the operations of each of the other components within the healthcare claim assessment system 110. The processor 112 may be any suitable processors, controllers, digital signal processors, or graphics processing units (GPUs) that can provide sufficient processing power depending on the configuration, purposes and requirements of the healthcare claim assessment system 110. In some embodiments, the processor 112 can include more than one processor with each processor being configured to perform different dedicated tasks.

The communication component 114 may include any interface that enables the healthcare claim assessment system 110 to communicate with other devices and systems. In some embodiments, the communication component 114 can include at least one of a serial port, a parallel port or a USB port. The communication component 114 may also include at least one of an Internet, Local Area Network (LAN), Ethernet, Firewire™, modem or digital subscriber line connection. Various combinations of these elements may be incorporated within the communication component 114.

For example, the communication component 114 may receive input from various input devices, such as a mouse, a keyboard, a touch screen, a thumbwheel, a track-pad, a track-ball, a card-reader, voice recognition software and the like depending on the requirements and implementation of the healthcare claim assessment system 110.

The data storage component 116 can include RAM, ROM, one or more hard drives, one or more flash drives or some other suitable data storage elements such as disk drives, etc. The data storage component 116 can also include one or more databases (not shown) for storing information relating to, for example, healthcare records data, healthcare claim data, itemized bill data, reject codes data, Centers for Medicare & Medicaid Services (CMS) policy data, payer policy data, reimbursement policy data, patient pattern data, historical healthcare claims data etc.

Similar to the data storage component 116, the external data storage 130 can also include RAM, ROM, one or more hard drives, one or more flash drives or some other suitable data storage elements such as disk drives, etc. In some embodiments, the external storage 130 can be similar to the data storage component 116 but located remotely from the healthcare claim assessment system 110 and accessible via the network 140. The external data storage 130 can also include one or more databases (not shown) for storing information relating to, for example, healthcare records data, healthcare claim data, itemized bill data, reject codes data, CMS policy data, payer policy data, reimbursement policy data, patient pattern data, historical healthcare claims data etc.

The computing device 120 can include any networked device operable to connect to the network 140. A networked device is a device capable of communicating with other devices through a network such as the network 140. A networked device may couple to the network 140 through a wired or wireless connection. Although only one computing device 120 is shown in FIG. 1, it will be understood that more computing devices 120 can connect to the network 140.

The computing device 120 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

The network 140 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX™, Ultra-wideband, Bluetooth®), Signalling System No. 7 (SS7) signaling network, fixed line, local area network, wide area network, and others, including any combination of these, capable of interfacing with, and enabling communication between, the healthcare claim assessment system 110, the external storage 130 and the computing device 120.

It will be understood that some components of FIG. 1, such as components of the healthcare claim assessment system 110 or the external data storage 130, can be implemented in a cloud computing environment.

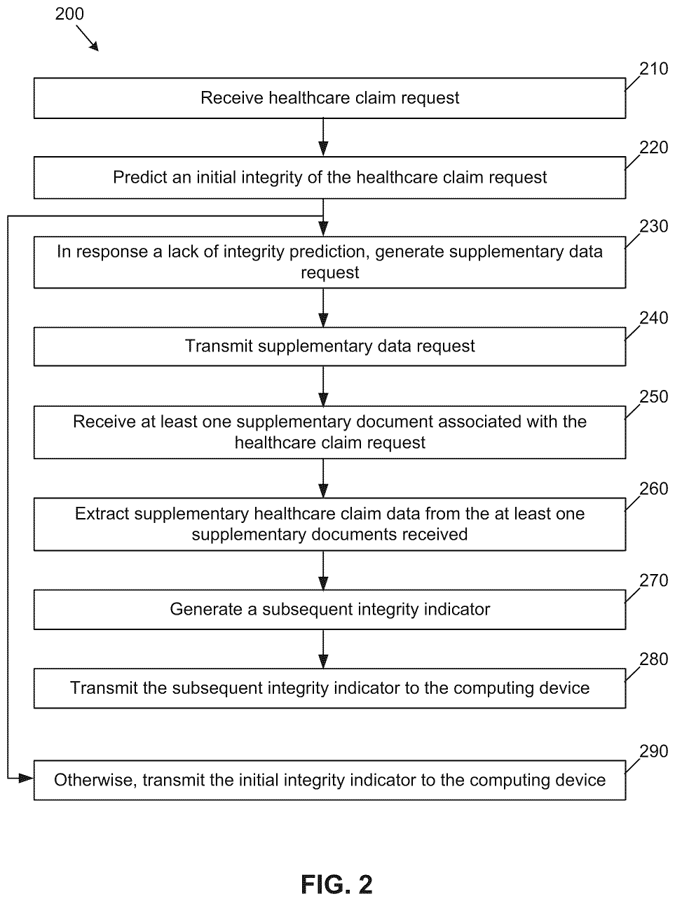

Reference is now made to FIG. 2, which illustrates a flowchart of an example embodiment of various methods of determining healthcare claim integrity. A healthcare claim assessment system, such as healthcare claim assessment system 110 having at least one processor 112 can be configured to implement the method 200.

At 210, the processor 112 is operable to receive a healthcare claim request. The healthcare claim request can include initial healthcare claim request data. The healthcare claim data can be received from a computing device, such as computing device 120. In some examples, the healthcare claim data may be received from external data storage 130 and relate to historical healthcare claims. In some embodiments, the computing device 120 can be associated with a patient (i.e., a patient submits the healthcare claim request). In some embodiments, the computing device 120 can be associated with a healthcare provider (i.e., a healthcare provider submits the healthcare claim request).

The healthcare claim request can relate to one or more healthcare claims. A healthcare claim can be a claim for payment related to a medical episode. The medical episode can be a single event (e.g., a patient visit to a healthcare provider) or can be a sequence of multiple events (e.g., the sequence of multiple events can include an initial patient visit for diagnosis, a medical imaging procedure, a surgical procedure and a post-surgery patient visit). The initial healthcare claim request data can include identification data related to the patient, the healthcare provider, and services (e.g., treatments or procedures) provided by the healthcare provider to the patient. For example, the initial healthcare claim request data can include claim codes, healthcare provider specialty codes etc.

In some cases, the healthcare claim request can include a pre-authorization request related to one or more healthcare claims. That is, the pre-authorization request can be related to a future healthcare claim. Pre-authorization may be required for healthcare claims associated with a high claim amount (e.g., a magnetic resonance imaging (MRI) procedure).

At 220, the processor 112 is operable to apply the initial healthcare claim request to at least one AI model, such as a claim integrity model, to predict an initial integrity of the healthcare claim request received at 210. In some embodiments, the processor 112 can generate an initial integrity prediction for each healthcare claim included in the received healthcare claim request.

Processor 112 can use a claim integrity model to generate the initial integrity predictions. The claim integrity model can be stored in a data storage component, such as data storage component 116. The claim integrity model can be any suitable machine-learning model that is configured to receive healthcare claim data as input and generate an initial integrity prediction for the healthcare claim data. The initial integrity prediction can be indicative of whether the healthcare claim request lacks integrity. A healthcare claim request can lack integrity due to issues, irregularities, or suspicious patterns such as incorrect payer and payee parties, non-compliance with the payer's payment policies, non-compliance with reimbursement criteria, deviations from national benchmarks, deviations from medical standards, and/or deviations from expected patient patterns. Such issues can be indicative of errors, fraud, waste, abuse etc.

The claim integrity model can generate the initial integrity prediction based on detection of one or more of the above-noted issues. In some embodiments, the initial integrity prediction can be binary. In other embodiments, the initial integrity prediction can be a probability or likelihood.

In some embodiments, the claim integrity model can be a Gradient Boosting Machine (GBM). The GBM can be trained to generate the initial integrity prediction based on patterns and relationships in training data used to train the GBM. The training data can include, for example, historical healthcare claim data. An ensemble learning technique can be used to build multiple weak learners (e.g., decision trees) sequentially, with each decision tree attempting to correct the errors of its predecessors. In some embodiments, the prediction output of the GBM can be generated by combining the predictions of all the decision trees. The GBM may provide prediction outputs with higher accuracy and robustness compared with a rule-based approach to generate the initial integrity prediction for a healthcare claim request.

The processor 112 can be adapted based on the initial integrity prediction. That is, the processor 112 can determine whether to further assess the integrity of the healthcare claim based on the initial integrity prediction. In response to the initial integrity prediction being indicative of a lack of integrity, at 230, the processor 112 is operable to automatically generate one or more supplementary data request for one or more supplementary documents associated with the healthcare claim request.

For example, processor 112 can identify one or more healthcare claim requests as potentially having healthcare claim integrity issues based on the integrity predictions at 220. For each identified healthcare claim request, the processor 112 can determine supplementary documents needed to assess the integrity of that claim. The processor 112 can generate a request for the supplementary documents.

The supplementary documents can include but is not limited to healthcare payment data and/or other healthcare data related to the identified healthcare claims. For example, the supplementary documents can be itemized invoices (i.e., itemized bills) associated the healthcare claims, patient health records (e.g., patient information, diagnosis information, discharge summaries) of a patient associated with the healthcare claims, and/or a policy document (e.g., insurance policy or contract).

At 240, the processor 112 can transmit the request to a corresponding computing device. In some embodiments, the computing device to which the supplementary data request is transmitted to may not be the same computing device from which the healthcare claim request was received from at 210. For example, the processor 112 can transmit a request for an itemized invoice to a computing device associated with a healthcare provider that issued the itemized invoice. In some embodiments, the processor 112 can transmit the request for a patient medical record to a computing device associated a different healthcare provider. For example, a patient medical record, including images, may be requested from a general practitioner that may have made a referral of the patient to a specialist. As another example, diagnosis codes can be requested from a medical practitioner to verify that a medical procedure included in a healthcare claim request is appropriate for the patient diagnosis. For another example, a healthcare claim may be eligible for payment under more than one insurance policy. Accordingly, information related to payment or non-payment of the healthcare claim may be requested from another insurer. Accordingly, the supplementary data request can be a customized and context-aware request.

In some embodiments, the processor 112 can improve the efficiency of the supplementary document retrieval process by using a generative artificial intelligence (AI) model to generate the supplementary data request.

At 250, the processor 112 can receive one or more of the supplementary documents. In some embodiments, supplementary documents can be received from multiple computing devices (e.g., different healthcare providers and/or patient).

At 260, the processor 112 is operable to extract supplementary healthcare claim data from the supplementary documents. The supplementary documents can be any type of documents, such as but not limited to invoices, images, medical reports etc. The supplementary documents can contain large amounts of unstructured information. Processor 112 can be operable to extract the supplementary healthcare claim data as structured data based on the unstructured information (and any available structured information) contained in the supplementary documents.

In some embodiments, the processor 112 can use an AI model to extract the supplementary healthcare claim data. In some embodiments, the AI model used to extract supplementary healthcare claim data at 260 can be a part of the AI model used to generate the supplementary data request at 230. In some embodiments, the AI model generate the supplementary data request to extract the supplementary data can be a different AI model than that used to generate the supplementary data request at 230.

In some embodiments, processor 112 can use an AI model to perform natural language processing (NLP) of the supplementary documents to understand textual content of the supplementary documents and extract supplementary healthcare claim data relevant to determining healthcare claim integrity. The processor 112 can tokenize text data within the supplementary document. That is, the processor 112 can generate a mathematical hash to represent the text data. Furthermore, the tokens can be health or medical-specific tokens. Thus, the supplementary healthcare claim data extracted from a supplementary document can relate to the health-specific tokens of the supplementary document. Tokens can be more suitable inputs for the AI model.

In some embodiments, the processor 112 can also use the AI model to perform optical character recognition (OCR) of the supplementary document. The processor 112 can also perform texture analysis to convert or segment unstructured information in the supplementary document to various textures. The processor 112 can also perform vectorization of the supplementary document.

With a health record or a discharge summary of the patient associated with the healthcare claim request, the processor 112 can extract one or more health elements from the health record. Health elements can include but are not limited to demographic information, healthcare provider information, facility information, a symptom, a condition, a diagnosis, a procedure, a treatment, a medication, or an incident experienced by the patient and related dates.

With an itemized invoice, the processor 112 can extract one or more invoiced items from the invoice. Each invoiced item can have a claim code corresponding to a procedure, treatment, or service provided to the patient.

At 270, the processor 112 is operable to apply the initial healthcare claim data and the supplementary healthcare claim data to the at least one claim integrity model to generate a subsequent integrity indicator. In some embodiments, processor 112 can generate a subsequent integrity indicator for each of the identified claims. With an invoice, the processor 112 can generate an item integrity indicator for each invoiced item of the invoice and generate the subsequent integrity indicator based on the item integrities for all invoiced items of the invoice.

In some embodiments, the item integrity indicator and/or the subsequent integrity indicator can be binary. In other embodiments, the item integrity indicator and/or the subsequent integrity indicator can be a probability or likelihood. Furthermore, in some embodiments, the item integrity indicator can be binary while the subsequent integrity indicator can be non-binary, such as a probability.

The subsequent integrity indicator can be based the medical necessity of the claim, such as the invoiced items. For example, the processor 112 can compare each item on an invoice with one or more health elements of the health record. The comparison can relate to a medical necessity criteria for the item. The medical necessity criteria for each item can be defined based on but not limited to national benchmarks, and/or patient patterns. For example, if none of the one or more health elements of the patient's health record are associated with the invoiced item (i.e., the one or more health elements do not have a medically necessary relationship with the invoiced item), the processor 112 can generate the item integrity indicator as being indicative of a of integrity.

The medical necessity criteria for each item can also be defined based on payer policies. When the processor 112 receives a policy document, the processor 112 can extract one or more policy elements from the policy document. Each policy element can include one or more rules related to one or more claim codes. The rules can be permissive (i.e., claim code eligible for payment) or restrictive (i.e., claim code ineligible for payment). The processor 112 can compare each invoiced item with at least one rule that is related to the claim code of the invoiced item. For example, if the claim code complies with one or more restrictive rules related to the claim code, the processor 112 can generate the item integrity indicator as being indicative of a lack of integrity. If the claim code does not comply with any restrictive rules related to the claim code and complies with one or more permissive rules related to the claim code, the processor 112 can generate the item integrity indicator as being indicative of sufficient integrity.

In some embodiments, the processor 112 can generate associations between related items on the same invoice and the subsequent integrity indicator for related items can be based on the association. For example, some treatments are commonly provided together (e.g., anesthesia and a root canal) and so the presence of both items on the same invoice can be likely medically necessary. However, unrelated treatments or treatments that are not typically performed together on the same invoice (e.g., anesthesia and routine dental scaling) may suggest that one of the treatments is not medically necessary and lacks integrity. Thus, the integrity of each item can be based on associations, or lack thereof, with other items on the same invoice.

As another example, the processor 112 can generate the subsequent integrity prediction based on the claim code associated with a medical procedure and determining whether the patients' diagnosis code and symptoms are consistent with the claimed medical procedure. In some examples, the claim integrity model can further generate the subsequent integrity prediction based on a patient medical record indicating the number of previous times the claimed medical procedure has been performed for that patient. As another example, the healthcare claim request can include a pre-authorization request for a particular procedure. The claim integrity model may generate the subsequent integrity prediction based on an evaluation of the patient's medical record including symptoms, diagnosis codes and whether alternative procedures have previously been performed. For example, pre-authorization of an MRI can be contingent on whether a Computer Tomography (CT) scan has already been performed, and the results of the CT scan being inconclusive. A CT scan is a less expensive procedure than an MRI and so the MRI may not be medically necessary unless a CT scan has been already been performed and the results of the CT scan being inconclusive.

In some embodiments, the processor 112 can receive supplementary documents at disparate times. Accordingly, the processor 112 can reiterate 250, 260, and 270 with additional supplementary healthcare claim data received from supplementary documents subsequent received. In each iteration, the processor 112 can use the additional healthcare claim data to regenerate the subsequent integrity indicator. That is, the processor 112 can adapt the subsequent integrity indicator according to the additional healthcare claim data. When the subsequent integrity indicator changes from a previous iteration, the processor 112 can transmit a notification of the change in the subsequent integrity indicator to the computing device 120.

For example, the processor 112 can receive a second supplementary document after transmitting a first subsequent integrity indicator to the computing device 120 for display. The first subsequent integrity indicator was based on the initial healthcare claim data and supplementary healthcare claim data from a first supplementary document. After extracting supplementary healthcare claim data from the second supplementary document, the processor 112 can re-apply the initial healthcare claim data and supplementary healthcare claim data from both the first supplementary document and the second supplementary document to the at least one claim integrity model 305 to generate a second subsequent integrity indicator. In some embodiments, if the second subsequent integrity indicator is different from the first subsequent integrity indicator, the processor 112 can transmit the second subsequent integrity indicator to the computing device 120 for display. In other embodiments, the processor 112 can automatically transmit the second subsequent integrity indicator to the computing device 120 for display without determining whether it is different from the first subsequent integrity indicator.

In some embodiments, the second supplementary document can be received in response to a request that was transmitted at the same time as the request for the first supplementary document. That is, the asynchronous timing of response can be simply due to different response times to synchronous supplementary data requests.

In some embodiments, the request for the second supplementary document can be generated after than the first subsequent integrity indicator is generated. For example, the processor 112 can automatically generate the second supplementary data request in response to the first subsequent integrity indicator being indicative that the healthcare claim lacks integrity.

At 280, the processor 112 can transmit the subsequent integrity indicator to the computing device 120. In some embodiments, the processor 112 can generate a notification displayable at the computing device 120 based on the subsequent integrity indicator. For example, the processor 112 can provide the notification via a user interface of computing device 120. The notification can provide an indication of one or more healthcare claim integrity issues related to identified healthcare claims. A user at computing device 120 can utilize the notification to make decisions regarding the healthcare claims (e.g., pre-payment approval decisions or post-payment recovery decisions). In some embodiments, the integrity indicator can be used to detect improper billing, overcharging, and/or unnecessary procedures.

In some embodiments, the processor 112 can generate a summary of a supplementary document and transmit the summary with the subsequent integrity indicator to the computing device 120 for display. The processor 112 can generate one or more pointers, each pointer can be associated with a portion of the supplementary document. The summary can include a least a portion of the supplementary healthcare claim data extracted from the supplementary document and at least one pointer related to the portion of the supplementary healthcare claim data. The summary can allow a user at the computing device 120 to quickly see the most relevant information from the supplementary document and navigate to the corresponding portion of the supplementary document containing the respective information. In some embodiments, the processor 112 can generate the pointers at step 260 as the supplementary healthcare claim data is extracted. In some embodiments, the pointers can relate to the various textures of the document.

If the initial integrity prediction generated at 220 did not indicate a lack of integrity, the method 200 can proceed to 290 without carrying out 230 to 280. At 290, the processor 112 can transmit the initial integrity indicator to the computing device 120. In some embodiments, the processor 112 can generate a notification displayable at the computing device based on the initial integrity indicator. For example, the processor 112 can provide the notification via a user interface of computing device 120. In some embodiments, further processes can be initiated based on the initial integrity indicator, such as payment of the healthcare care claim.

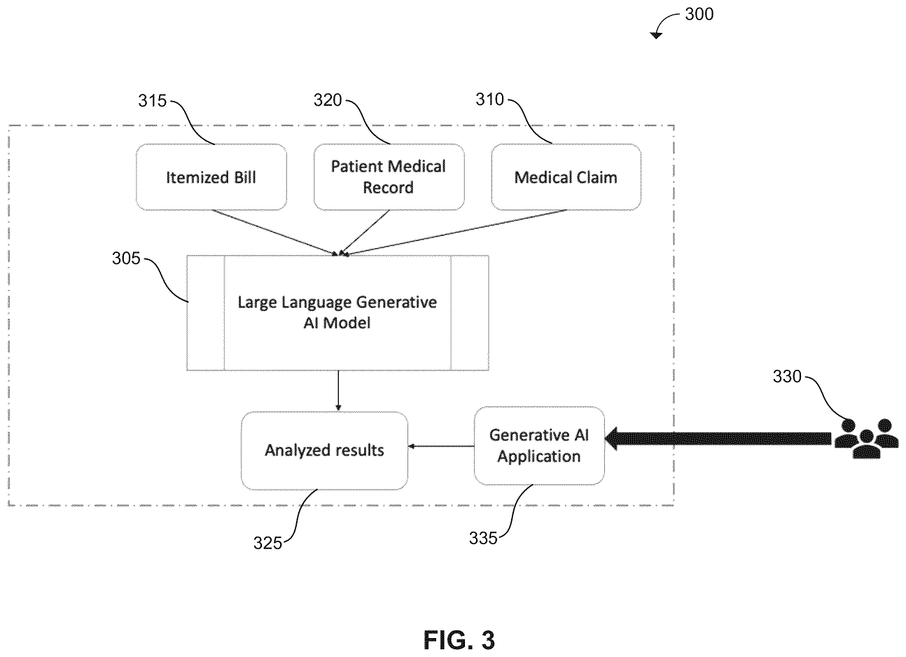

Processor 112 can use the claim integrity model to generate the initial integrity prediction and/or the subsequent integrity indicator. Referring now to FIG. 3, shown therein is a diagram 300 of an example data flow for determining healthcare claim integrity using an example claim integrity model 305. In the illustrated example, the claim integrity model 305 is a large language generative AI model. The claim integrity model 305 can receive as input healthcare claim data (e.g., medical claim 310) and supplementary data (e.g., itemized bill 315 and patient medical record 320). A notification (e.g., analyzed results 325) can be provided to users 330 via a communication component (e.g., generative AI application 335).

The historical healthcare claim data may be utilized to train the claim integrity model 305 to evaluate an itemized bill 315 and patient medical records 320 for various aspects of healthcare claim integrity and generate a corresponding integrity indicator. For example, the claim integrity model 305 can be trained to detect improper billing (e.g., incorrect payer and payee parties, non-compliance with the payer's payment policies, deviations from national benchmarks, deviations from medical standards, and/or billing errors), overcharging, unnecessary procedures, fraud, waste, abuse, etc. The claim integrity model 305 can evaluate the itemized bill 315 and patient medical records 320 by generating associations and mappings between medical services or products documented in the itemized bill 315, patient medical records 320, and corresponding healthcare claim integrity criteria. The healthcare claim integrity criteria may be based on the training data used for training the claim integrity model 305.

In some embodiments, the large language generative AI model 305 may be pre-trained using a large corpus of general-purpose training data. The pre-trained large language generative AI model 305 may be further trained using specialized training data related to healthcare or medical claims.

The large language generative AI model 305 may be trained using training data that includes healthcare claim data, electronic health records (EHRs), patient demographic data, healthcare provider data, healthcare claim decision data, healthcare claim audit data, and/or healthcare claim integrity data. Raw data may be collected and pre-processed to provide suitable and accurate training data. For example, the raw data may be pre-processed to remove duplicates and handle missing values, normalize numerical features (e.g., using z-score normalization), and/or tokenize text data with medical-specific tokenizers such as, for example, Anthropic or BioBERT. For text data, the tokenization can convert the text into tokens, improving its' suitability as training data.

The large language generative AI model 305 may be trained using the above-described training data to extract relevant information from received healthcare claim requests/supplementary documents, and/or generate the integrity indicator for a healthcare claim requests. The large language generative AI model 305 may be trained, for example, to extract relevant information including medical terms, patient information, patient discharge summary information, and/or patient diagnosis information.

The large language generative AI model 305 may be trained to extract the relevant information from different types of documents including healthcare policies, contracts, patient medical records, itemized bills, prior authorization documents, and/or healthcare claim appeal documents. The large language generative AI model 305 may tokenize a received document and identify relevant sections of the document for information extraction based on the tokenization.

The trained large language generative AI model 305 may identify one or more correlations in received data. For example, correlations between a healthcare claim for a patient and the patient's medical record (e.g., correlate a healthcare claim related to a patient's sepsis diagnosis with the patient's medical record describing a cut suffered by the patient). This can enable the trained large language generative AI model 305 to determine, for example, if each portion of a healthcare claim is supported or substantiated by the patient's medical record.

Any suitable large language generative AI model 305 may be used. In some embodiments, an entropic model may be used. In other embodiments, a different model may be used.

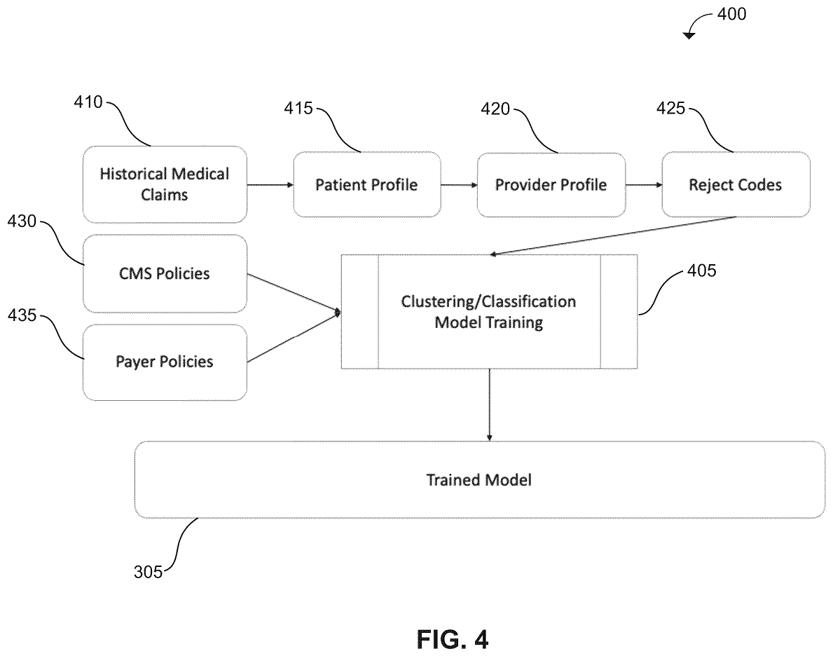

Referring now to FIG. 4, shown therein is a diagram 400 for an example data flow for training the example claim integrity model 305. The model training 405 can utilize training data including historical medical claims data 410, patient profile data 415, provider profile data 420, reject codes data 425, CMS policies data 430, and/or payer policies data 435. The training data can be based on data received from computing device 120 and/or external data storage 130.

In some embodiments, the claim integrity model 305 can be trained using supervised learning methods. The training data can include labeled examples of (i) healthcare claims with healthcare claim integrity issues and (ii) healthcare claims without healthcare claim integrity issues. The training data can also include data for multiple features including, for example, patient profile, healthcare provider profile, policies, reject codes, audit results, reasons for the healthcare claim approval/rejection etc. The supervised learning method can utilize a Random Forest algorithm for training the claim integrity model to discern patterns in the training data.

In some embodiments, the claim integrity model 305 can be trained using unsupervised learning methods. The training data can include unlabeled examples of healthcare claims and associated data (e.g., patient profile, healthcare provider profile, policies, etc.). The unsupervised learning method can utilize a k-means algorithm to train the claim integrity model to identify patterns and relationships within the training data (e.g., prediction outputs can be generated by clustering similar patient profiles based on hidden features in the unlabeled training data).

In some embodiments, the claim integrity model 305 can be trained using semi-supervised learning methods. The training data can include both labeled and unlabeled examples. The semi-supervised learning methods can use the Expectation-Maximization (EM) algorithm to train the claim integrity model 305 based on the labeled and unlabeled examples. By iteratively estimating hidden variables and maximizing likelihoods, the EM algorithm can enable the claim integrity model 305 to generate prediction outputs based on unlabeled data while simultaneously learning from labeled data.

In some embodiments, the claim integrity model 305 can be trained using reinforcement learning. The reinforcement learning may use the Deep Q-Network (DQN) algorithm to train the claim integrity model 305 to make optimal choices through trial-and-error feedback. By interacting with an environment, the model receives rewards or penalties based on its actions, enabling it to improve its decision-making capabilities over time.

The trained claim integrity model 305 can detect one or more healthcare claim integrity issues with a healthcare claim and generate a corresponding integrity indicator. For example, the claim integrity model 305 can detect a healthcare claim integrity issue where an EKG procedure is listed in an itemized bill 315 but there is no EKG data in the patient's medical record 320. As another example, the claim integrity model 305 can detect a healthcare claim integrity issue where an itemized bill 315 includes two payment codes that should not be billed together as per payer payment policy. As another example, the claim integrity model 305 can detect a healthcare claim integrity issue where an itemized bill 315 includes an item that is not compliant with payer payment policy (e.g., a bill item for a surgical procedure, payer payment policy requires prior authorization before surgical procedures and the patient medical record 320 does not include prior authorization). As another example, the claim integrity model 305 can detect a healthcare claim integrity issue where an itemized bill 315 includes improper payment codes (e.g., a bill item for inpatient cost but where patient medical record 320 indicates that the item should have been billed as a patient observation cost).

Reference is now made back to FIG. 2. In some embodiments, after 280, the processor 112 can be operable to enable interactive communication with one or more users. For example, the processor 112 can receive user questions regarding the reasoning used to generate the subsequent integrity indicator and can provide a summary explanation in response. The processor 112 can use the claim integrity model 305 to provide natural language summary explanations of reasoning used to generate the subsequent integrity indicator. The summary explanations can be used, for example, by healthcare payment auditors to evaluate the healthcare claim assessment process. The healthcare payment auditors can include, for example, payers (e.g., insurance companies), healthcare providers (e.g., clinicians), or third-party vendors providing healthcare auditing services.

As another example of interactive communication, the processor 112 can be operable to receive user input regarding the generated subsequent integrity indicator. In some embodiments, the processor 112 can utilize the received user input for further training of the integrity prediction model, the claim integrity model 305 and/or any other models used by the disclosed systems and methods.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

1. A computer-implemented method for adaptive determination of healthcare claim integrity, the method comprising operating at least one processor to:
receive a healthcare claim request from a computing device, the healthcare claim request comprising initial healthcare claim request data;
apply the initial healthcare claim request data to at least one claim integrity model to predict an initial integrity of the healthcare claim request; and
in response to the initial integrity prediction being indicative that the healthcare claim request lacks integrity,
automatically generate one or more supplementary data requests for one or more supplementary documents associated with the healthcare claim request;
transmit the one or more supplementary data requests to corresponding computing devices associated with the one or more supplementary documents;
receive at least one supplementary document of the one or more supplementary documents;
extract supplementary healthcare claim data from the at least one supplementary documents received;
apply the initial healthcare claim data and supplementary healthcare claim data to the at least one claim integrity model to generate a subsequent integrity indicator; and
transmit the subsequent integrity indicator to the computing device for display;
otherwise, transmit the initial integrity indicator to the computing device for display.

2. The computer-implemented method of claim 1, comprises operating the at least one processor to:
receive a second supplementary document after transmitting a first subsequent integrity indicator to the computing device for display, the first subsequent integrity indicator being based on the initial healthcare claim data and supplementary healthcare claim data from a first supplementary document;
re-apply the initial healthcare claim data and supplementary healthcare claim data from the first supplementary document and the second supplementary document to the at least one claim integrity model to generate a second subsequent integrity indicator;
compare the second subsequent integrity indicator with the first subsequent integrity indicator; and
in response to determining that the second subsequent integrity indicator is different from the first subsequent integrity indicator, transmit the second subsequent integrity indicator to the computing device for display.

3. The computer-implemented method of claim 1, comprises operating the at least one processor to:
apply the initial healthcare claim request data to a first claim integrity model to predict the initial integrity of the healthcare claim request; and
apply the initial healthcare claim data and supplementary healthcare claim data to a second claim integrity model to generate the subsequent integrity indicator.

4. The computer-implemented method of claim 1, wherein the healthcare claim request comprises a pre-authorization request.

5. The computer-implemented method of claim 1, wherein the initial integrity of the healthcare claim request is binary.

6. The computer-implemented method of claim 1, comprises operating the at least one processor to apply a generative artificial intelligence (AI) model to automatically generate one or more supplementary data requests for one or more supplementary documents associated with the healthcare claim request and extract supplementary healthcare claim data from the at least one supplementary documents received.

7. The computer-implemented method of claim 6, comprises operating the at least one processor to apply natural language processing to extract the supplementary healthcare claim data from the at least one supplementary documents received, the supplementary healthcare claim data comprising at least one health-specific token representative of text data within the at least one supplementary document received.

8. The computer-implemented method of claim 7, further comprises operating the at least one processor to apply optical character recognition to extract the supplementary healthcare claim data from the at least one supplementary documents received.

9. The computer-implemented method of claim 6, comprises operating the at least one processor to:
receive a health record of a patient associated with the healthcare claim request; and
extract one or more health elements from the health record, each of the one or more health elements corresponding to demographic information, healthcare provider information, facility information, a symptom, a condition, a diagnosis, a procedure, a treatment, a medication, or an incident experienced by the patient.

10. The computer-implemented method of claim 9, comprises operating the at least one processor to:
receive an invoice corresponding to the healthcare claim request;
extract one or more invoiced items from the invoice, each of the one or more invoiced items having a claim code corresponding to a procedure, a treatment, or a service provided to the patient; and
for each invoiced item of the one or more invoiced items,
compare the invoiced item to the one or more health elements of the health record; and
generate an item integrity indicator for the invoiced item at least based on the comparison of the invoiced item to the one or more health elements.

11. The computer-implemented method of claim 10, comprises operating the at least one processor to, in response to determining that none of the one or more health elements are associated with the invoiced item, generate the item integrity indicator as being indicative of a lack of integrity.

12. The computer-implemented method of claim 10, comprises operating the at least one processor to:
receive a policy document associated with the healthcare claim request;
extract one or more policy elements from the policy document, each policy element comprising one or more rules related to one or more claim codes, each rule of the one or more rules being either a permissive rule or a restrictive rule;
for each invoiced item of the one or more invoiced items,
compare the claim code of the invoiced item to at least one rule that is related to the claim code of the invoiced item; and
generate the item integrity indicator for the invoiced item at least based on the comparison of the invoiced item to the at least one rules.

13. The computer-implemented method of claim 12, comprises operating the at least one processor to:
in response to determining that the claim code complies with one or more restrictive rules related to the claim code, generate the item integrity indicator as being indicative of a lack of integrity; and
in response to determining that the claim code does not comply with any restrictive rules related to the claim code and determining that the claim code complies with one or more permissive rules related to the claim code, generate the item integrity indicator as being indicative of a sufficient integrity.

14. The computer-implemented method of claim 10, wherein the item integrity indicator for each invoiced item of the one or more invoiced items is binary.

15. The computer-implemented method of claim 10, comprises operating the at least one processor to generate the subsequent integrity indicator based on the item integrity of each of the one or more invoiced items of the invoice.

16. The computer-implemented method of claim 1, comprises operating the at least one processor to train the at least one claim integrity model using the initial integrity prediction, the subsequent integrity indicator, the initial healthcare claim data, and the supplementary healthcare claim data.

17. The computer-implemented method of claim 1, comprises operating the at least one processor to:
generate one or more pointers, each pointer being associated with a portion of the at least one supplementary document;
generate a summary of the at least one supplementary document, the summary comprising at least a portion of the supplementary healthcare claim data extracted from the at least one supplementary document and at least one pointer related to the supplementary healthcare claim data, the at least one pointer related to the supplementary healthcare claim data being one of the one or more pointers of the at least one supplementary document; and
transmit the summary of the at least one supplementary document with the subsequent integrity indicator to the computing device for display.

18. A system for adaptive determination of healthcare claim integrity comprising at least one processor configured to:
receive a healthcare claim request from a computing device, the healthcare claim request comprising initial healthcare claim request data;
apply the initial healthcare claim request data to at least one claim integrity model to predict an initial integrity of the healthcare claim request; and
in response to the initial integrity prediction being indicative that the healthcare claim request lacks integrity,
automatically generate one or more supplementary data requests for one or more supplementary documents associated with the healthcare claim request;
transmit the one or more supplementary data requests to corresponding computing devices associated with the one or more supplementary documents;
receive at least one supplementary document of the one or more supplementary documents;
extract supplementary healthcare claim data from the at least one supplementary documents received;
apply the initial healthcare claim data and supplementary healthcare claim data to the at least one claim integrity model to generate a subsequent integrity indicator; and
transmit the subsequent integrity indicator to the computing device for display;
otherwise, transmit the initial integrity indicator to the computing device for display.

19. The system of claim 18, wherein the at least one processor is configured to:
receive a second supplementary document after transmitting a first subsequent integrity indicator to the computing device for display, the first subsequent integrity indicator being based on the initial healthcare claim data and supplementary healthcare claim data from a first supplementary document;
re-apply the initial healthcare claim data and supplementary healthcare claim data from the first supplementary document and the second supplementary document to the at least one claim integrity model to generate a second subsequent integrity indicator;
compare the second subsequent integrity indicator with the first subsequent integrity indicator; and
in response to determining that the second subsequent integrity indicator is different from the first subsequent integrity indicator, transmit the second subsequent integrity indicator to the computing device for display.

20. (canceled)

21. The system of any one of claim 18, wherein the healthcare claim request comprises a pre-authorization request.

22.-34. (canceled)
